(19) United States
(12) Patent Application Publication
(10) Pub. No.: US 2020/0030178 A1
(43) Pub. Date: Jan. 30, 2020

(54) Neck and Back Muscle Stretching Device

(71) Applicant: Aspen Medical Products, LLC, Irvine, CA (US)

(72) Inventor: Geoffrey Garth, Long Beach, CA (US)

(21) Appl. No.: 16/521,514

(22) Filed: Jul. 24, 2019

Related U.S. Application Data
(63) Continuation-in-part of application No. 16/519,624, filed on Jul. 23, 2019.
(60) Provisional application No. 62/702,439, filed on Jul. 24, 2018.

(51) Int. Cl. A61H 1/02

(52) U.S. Cl. CPC A61H 1/0296; A61H 1/0218; A61H 2201/1671; A61H 2201/1253; A61H 2201/1611; A61H 2001/0203

(57) ABSTRACT

A cervical traction device has and occipital tractioning member and a handle. The device is positioned between the occiput of a person and the floor or other surface. Rotation of the handle away from the person's torso exerts opposite forces against the occiput and the surface, which exerts a tractioning (extension) force upon the cervical spine. The occipital tractioning member can advantageously comprise first and second spaced apart plastic spheres.

This application claims priority to U.S. provisional application 62/702,439, filed Jul. 24, 2018, and is a continuation-in-part of U.S. utility application Ser. No. 16/519,624, filed Jul. 24, 2019. This and all other extrinsic references identified herein are incorporated by reference to the same extent as if each individual reference or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is muscle stretching devices.

### BACKGROUND

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Muscle stretching devices exist to manipulate the fibers of a muscle in various ways and loosen knots, allowing a taught muscle to regain flexibility and malleability. U.S. Pat. No. 6,390,997 to Vitko teaches a back stimulator comprising a series of roller balls that allows a person to roll on the series of roller balls to massage muscles along a back of the person. Vitko's apparatus, however, is spread along a large surface area, making it difficult for a person to target a specific muscle knot for massaging.

WO2014/015322 to Allen teaches a massager comprising an oversleeve holding a pair of balls which enables an individual to perform a variety of massages by applying targeted pressure to effective muscle groups. Allen's massager, however, either depends upon the user applying his/her own body weight accurately on the massager to target specific muscles, which lacks accuracy, or depends upon the user applying the massager to a target area using the user's hands, which lacks power.

WO 2017/147409 to Gagliano teaches a psychical therapy massage ball device coupled to a tubular sleeve that holds the massage ball in a cavity. Gagliano's device comprises a pair of handles extending from each end of the massage ball receiving cavity that allows a person to pull Gagliano's device to targeted areas using both hands of the person—increasing the force applied by the massage ball. Gagliano's device, however, fails to utilize the person's own body weight, which prevents additional force and power from being applied to the person's sore muscle.

Thus, there remains a need for a system and method that improves the ability of a person to manually apply a greater amount of inline traction force across an area of the body—such as the cervical spine—where the person is in control of the force being applied.

### BRIEF DESCRIPTION OF THE DRAWING

FIG. 1 shows a plan view of an exemplary cervical traction device.

FIG. 2 shows an alternative plan view of the exemplary cervical traction device of FIG. 1.

FIG. 3 shows a plan view of an alternative cervical traction device.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

Various objects, features, aspects and advantages of the inventive subject matter will become more apparent from the following detailed description of preferred embodiments, along with the accompanying drawing figures in which like numerals represent like components.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The inventive subject matter provides apparatus, systems, and methods for providing targeted traction to a person's cervical spine utilizing both the person's body weight and arm strength. As used herein, providing “traction” force to the cervical spine comprises providing a force on the cervical spine to temporarily increase the distance between at least two discs of the cervical spine. This is to be differentiated from a device that provides a “flossing” or “massaging” force to a muscle of the person, which temporarily compresses a muscle of the user.

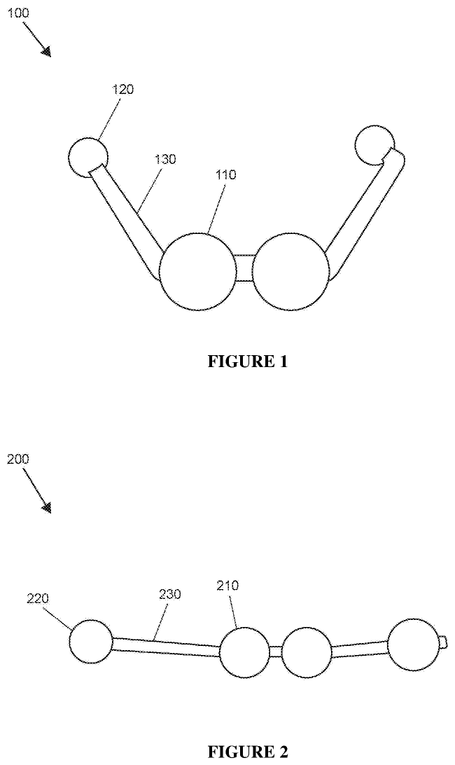

An exemplary cervical traction device 100 is disclosed in FIG. 1, having a pair of occipital contact members 110 coupled to a pair of handles 130.

The occipital contact members 110 comprise a pair of spheres with an axle impaling both spheres through a center, allowing the spheres to roll along a surface when either handle is pushed to one side while the spheres are touching the surface. While occipital contact members 110 are shown here as a pair of spheres, occipital contact members 110 could be any shaped part fixed on a shaft such that the occipital contact member does not turn freely on the shaft, but rather rotates as the shaft is rotated. The occipital contact members 110 preferably comprise an elastomeric material having a high dry static coefficient of friction, preventing the occipital contact members from sliding one way or another along a dry surface, such as a carpet, a rug, or a floor mat.

As used herein a coefficient of friction is expressed as F_{f}=μN, where F_{f}=frictional force (N, lb), μ=static (μs) or kinetic (μk) frictional coefficient, and N=normal force between the surfaces (N, lb). Preferably the coefficient of friction of occipital contact members 110 is greater than 0.2, 0.3, 0.4, 0.5 0.6, 0.7, or even 1.0 when dry and static on a surface. Preferably, the occipital contact members 110 have a surface that is coated in an elastomeric material, such as isoprene rubber, with a higher-than-average coefficient of friction. When sufficient pressure is generated to push the occipital contact members 110 against a surface (typically by the user resting their occiput on top the occipital contact members 110 which rest on the floor), there should be no slippage either of the occipital contact members 110 against the surface or the occipital contact members 110 against the occiput. This allows the rolling movement to translate directly into a force that produces a degree of extension of the cervical spine while the cervical spine is distracted.

While occipital contact members 110 are shown as two spheres having a diameter of at least 10 centimeters and a distance of at most 7 centimeters between the spheres, the muscle traction members 110 could be sized and disposed in any suitable fashion to roll along a surface when at least one of handles 130 are pushed. For example, the spheres could be distanced at most 1 centimeter, 2 centimeters, 5 centimeters or 10 cm away from another, and may have a diameter of at least 5 centimeters, 10 centimeters, 15 centimeters or even 20 centimeters. The occipital contact members may not be spheres at all, but could be any shape having a cross-sectional area with all diameters equal, such as a cross-sectional circle or a cross-sectional Reuleaux triangle. In some embodiments, the cross-sectional areas need not be exactly equal, and could form a part of an ovoid with a curve that easily rolls on a surface area. The occipital contact members 110 may even comprise a single member, such as a foam roller, or preferably an hourglass-shaped foam roller having a valley within which a user can place the back of their neck that is “hugged” on either side by the valley of the foam roller.

Preferably occipital contact members 110 comprise an elastomeric and/or a textured elastic surface that increases the surface area of the occipital contact members as compared with a smooth surface, allowing the surface of muscle-traction members 110 to grip the surface upon which it is rolling, as well as a surface of the occiput of the person. As one side of the occipital contact members 110 roll along the surface, the other side of the occipital contact members 110 forces the head of the patient to move in one direction. Preferably, the occipital contact members have a surface with a high coefficient of friction such that the surface of the occipital contact members grip the occiput of the user such that the user's head is forced into an extended and distracted position as the occipital contact members 110 roll along a surface. The coefficient of friction and the downward force applied by the patient are such that no slippage occurs, as most of the force being applied is directed to the neck and cervical spine.

Preferably the user lays their occiput on top of the occipital contact members 110 while lying in a supine position while cervical traction device 100 rests against a substantially horizontal surface (e.g. within 5° of the horizon), allowing the weight of their head to nestle within the valley formed by the spherical shapes of occipital contact members 110. The weight of the user's torso then acts as an anchor against the traction force created by occipital contact members 110 when device 100 is rotated when the user pushes handles 130 in a cephalad direction. While the user could interpose occipital contact members 110 against any surface, for example a wall or a table, the surface is preferably less than 45° from a flat horizontal position in order to maximize the normal force provided by the weight of the user. In some embodiment, the coefficient of friction between the occipital contact members 110 and the surface and the user's neck is so high that a user pushing up on handles 130 could drag the user's body across the surface.

Preferably, the dimensions of cervical traction device 100 are such that the innermost portion of the handle is disposed within 40 centimeters, 30 centimeters, 20 centimeters, or even 10 centimeters from a side of the user's body, and the tip of the handle is disposed more than 5 centimeters, 10 centimeters, 20 centimeters, 30 centimeters, or even 40 centimeters from a side of the user's body, allowing the user to easily reach any portion of the handles and move one or both of the handles to generate traction along his/her occiput.

The current embodiment also discloses a muscle massaging member 120, which is preferably made from a more dense elastomeric material, used to target and floss muscle knots at any portion of the body, for example the neck or lower back area. The muscle massaging member 120 is coupled to a side of handle 130, allowing for different kinds of muscle targeting. Protrusions on the opposite side of handle 130 provide a fulcrum when placed on a hard surface, such as a table top, allowing muscle massaging member 120 to target certain muscles such as the user's hamstrings. The orientation of both muscle massaging member 120 and the handle that it is mounted on facilitates flossing of the target muscle as movement of the handle causes the ball to move in an arc, in whatever direction is desirable.

FIG. 2 shows an alternative embodiment of a muscle traction device 200 having two occipital contact members 210, handle 230, and muscle massaging member 220.

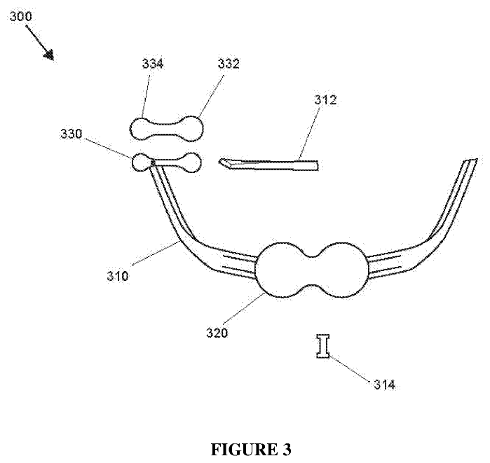

FIG. 3 shows an alternative embodiment of a muscle traction device 300 having a core 310, occipital contact member 320, and muscle massaging member 330. Core 310 comprises a handle 312 and a center 314 that spears through occipital contact member 320, which is shaped as a pair of conjoined spheres with a textured surface that improves the level of contact between occipital contact member 320 and a user's occiput and/or a floor surface.

Muscle massaging member 330 has a fulcrum 334 and a massaging member 332, which allows the fulcrum 334 of muscle traction device 300 to rest against a surface while a user rests a muscle to floss against massaging member 332. The coefficient of friction of fulcrum 334 is preferably also high, similar to the coefficient of friction of occipital contact members 110, to minimize slippage of fulcrum 334 when fulcrum 334 rests upon a surface. Here, massaging member 332 is shaped slightly larger than fulcrum 334, but any suitable shape could be used for flossing an appropriate muscle. In some embodiments, muscle massaging member 330 could be detached such that massaging members of various shapes and sizes could be attached to the end of handle 310. When muscle massaging member 330 is appropriately positioned with fulcrum 334 against a surface and massaging member 332 appropriately positioned against a user's muscle (e.g. a user's hamstring muscles or lumbar muscles), the user could manipulate the other end of handle 310 to floss the muscle in any suitable manner. Usage of such a muscle massaging member 330 provides more targeted pressure in a localized area, where handle 310 allows a user to manipulate massaging member 332 with advantageous movements. In some embodiments, fulcrum 334 and massaging member 332 could have differing levels of elasticity, for example a higher level of elasticity for fulcrum 334 than massaging member 332.

It should be apparent to those skilled in the art that many more modifications besides those already described are possible without departing from the inventive concepts herein. For example, a user may use occipital contact members 110 or 320 to floss a muscle in addition to providing traction to an occiput. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A cervical traction device for tractioning a neck of a user, comprising:
a handle having at least one arm; and
an occipital contact member extending away from the handle, and configured to operate as a shaft, rotating as the handle is rotated;
such that the neck of the user is distracted when the occipital contact member is positioned between a surface and an occipital region of the user's head, and the handle is moved to rotate the occipital contact member.

2. The cervical traction device of claim 1, wherein the occipital contact member comprises an elastomeric material.

3. The cervical traction device of claim 1, wherein the occipital contact member comprises a textured elastic surface.

4. The cervical traction device of claim 1, wherein the cross-section comprises at least one of a circle and a Reuleaux triangle.

5. The cervical traction device of claim 1, wherein the occipital contact member comprises at least first and second spheres having a diameter of at least 5 centimeters, and distanced apart by at most 10 centimeters.

6. The cervical traction device of claim 1, wherein the handle includes an axle that passes longitudinally through the occipital contact member.

7. The cervical traction device of claim 1, wherein the cervical traction member has a floor side and a neck side, and the floor side comprises a material having a dry static coefficient of friction of at least 0.5.

8. The cervical traction device of claim 7, wherein the neck side comprises the material having a dry static coefficient of friction of at least 0.5.

9. A method of generating traction along the cervical spine of a person, comprising:
disposing an elongated occipital contact member in between a surface and the person's occiput; and
using a handle to rotate the occipital contact member, thereby causing the occipital contact member to exert forces in opposite directions against the surface the occiput, and inducing a traction force upon the cervical spine.

10. The method of claim 9, wherein the occipital contact member comprises at least first and second spheres having a diameter of at least 5 centimeters, and distanced apart by at most 10 centimeters, and further comprising disposing the person's occiput between the first and second spheres.

11. The method of claim 9, further comprising pushing the handle away from a torso of the person to force the user's occiput into a degree of extension.

12. The method of claim 9, further comprising using a portion of the person's body as the surface.
